(19) United States
(12) Patent Application Publication
(10) Pub. No.: US 2024/0123857 A1
(43) Pub. Date: Apr. 18, 2024

(54) METHOD OF COLLECTING CHARGER INFORMATION AND METHOD OF UTILIZING COLLECTED CHARGER INFORMATION

(71) Applicants: Hyundai Motor Company, Seoul (KR); Kia Corporation, Seoul (KR)

(72) Inventor: Young-Sik KIM, Anyang-si (KR)

(73) Assignees: Hyundai Motor Company, Seoul (KR); Kia Corporation, Seoul (KR)

(21) Appl. No.: 18/242,716

(22) Filed: Sep. 6, 2023

(30) Foreign Application Priority Data
Oct. 12, 2022 (KR) 10-2022-0130340

(51) Int. Cl. B60L 53/66; G06F 1/28

(52) U.S. Cl. CPC B60L 53/66; G06F 1/28

(57) ABSTRACT

A method of collecting charger information which is capable of obtaining information of chargers around the world and making the obtained information into a database, includes collecting, by a charging control unit in a vehicle, charger identification information from a charger connected to the vehicle for charging, determining whether the charger is a new charger from the collected charger identification information, and when a result of the determining indicates that the charger is the new charger, collecting, by the charging control unit, charger output information and transmitting the charger identification information and the charger output information to a management server.

### CROSS-REFERENCE TO RELATED APPLICATION

The present application claims priority to Korean Patent Application No. 10-2022-0130340, filed on Oct. 12, 2022, the entire contents of which is incorporated herein for all purposes by this reference.

### BACKGROUND OF THE PRESENT DISCLOSURE

### Field of the Present Disclosure

The present disclosure relates to a technology for managing charger information, and more particularly, to a technology for collecting charger information using vehicle data and providing charger information desired by a customer to improve charging convenience.

### Description of Related Art

Petroleum energy, which has been the main energy source for hundreds of years, is being depleted, and further the consumption thereof has caused air pollution and atmospheric changes. In this regard, research on alternative energy sources is being actively conducted.

In some fields, alternative energy sources such as wind power, water power, and solar energy instead of petroleum energy resources have already been commercialized, and research on vehicles using alternative energy sources as fuel has also been realized to preoccupy the market in the field of vehicles.

With the commercialization of electric vehicles, there is an increasing demand for electric vehicle chargers or facilities. However, the electric vehicle chargers or facilities are provided in some limited places, and unlike gas stations, the supply thereof is still insufficient, which causes inconvenience to electric vehicle users.

There is a problem in that only the charger location is displayed and searched on the Audio Video Navigation (AVN) map. Furthermore, there is a problem in that only the charger location desired by a user are guided.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of collecting charger information which is configured for obtaining information on chargers around the world and making the obtained information a database.

Another object of the present disclosure is to provide a method of utilizing collected charger information which is configured for reducing charging time and improving customer convenience.

Yet another object of the present disclosure is to provide a method of being configured for presenting information on the remaining charging time to a driver by determining the remaining charging time based on the current charging state of the vehicle.

An exemplary embodiment of the present disclosure provides a method of collecting charger information which is configured for obtaining information on chargers around the world and making the obtained information a database.

The method of collecting charger information includes: collecting, by a charging control unit in a vehicle, charger identification information from a charger connected to the vehicle for charging; determining whether the charger is a new charger from the collected charger identification information; and when a result of the determining indicates that the charger is the new charger, collecting, by the charging control unit, charger output information and transmitting the charger identification information and the charger output information to a management server.

In the instant case, the charger identification information and the charger output information may be extracted from a vehicle message transmitted into the vehicle.

Furthermore, the charger identification information may include a media access control (MAC) address and location information of the charger.

Furthermore, the determining of whether the charger is the new charger may include: comparing the MAC address and the location information of the collected charger identification information to a MAC address and location information of a pre-stored charger information list.

Furthermore, the pre-stored charger information list may be transmitted in real time from the management server or periodically synchronized with the management server.

Furthermore, the method may include: reflecting, by the charging control unit, the charger identification information and the charger output information on the new charger to a head unit.

Furthermore, the method may include: reflecting, by the charging control unit or the management server, the charger identification information and the charger output information on the new charger to a charging related application.

Furthermore, the charger output information may include charging power, voltage, and current of the charger.

Furthermore, the charging control unit may proceed with charging when a result of the determining indicates that the charger is not the new charger.

Another exemplary embodiment of the present disclosure provides a method of utilizing collected charger information, the method including: receiving a charger search request from a user; identifying, by a charging control unit, a charger corresponding to the charger search request; and providing, by the charging control unit, the user with charging information on the identified charger when the charging control unit concludes that the identified charger belongs to a charger information list including the charging information.

In the instant case, the charging information may include at least one of current, voltage, charging power, charging time, and charging speed.

Furthermore, the providing of the user with the charging information may include: receiving, by the charging control unit, a charger selection command for the identified charger; and guiding, by the charging control unit, a traveling route from a current location of a vehicle to a selected charger.

Furthermore, the guiding of the traveling route may include: determining, by the charging control unit, whether the vehicle is configured for traveling according to the traveling route based on a charging state of a battery of the vehicle.

Furthermore, the method may include: displaying, by the charging control unit, remaining charging time using the charging information

Furthermore, the method may include: receiving, by a management server, the charger search request directly from the user; and when the user selects a charger corresponding to the charger search request, displaying charging information on the selected charger.

Furthermore, the method may include: after the displaying of the charging information, proceeding with charging by the charging control unit when the vehicle travels along the traveling route and is connected to the selected charger for charging.

According to an exemplary embodiment of the present disclosure, it is possible to collect information on a charger using vehicle data and make a database based on the collected information.

Furthermore, it is possible to improve charging convenience by providing collected charger information.

Furthermore, it is possible to collect and reflect corresponding information in real time during charging with a charger.

Furthermore, it is possible to set charger conditions during searching for a charger.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a charging system according to an exemplary embodiment of the present disclosure.

FIG. 2 is a detailed block diagram of a vehicle illustrated in FIG. 1.

FIG. 3 is a detailed block diagram of a charging control unit illustrated in FIG. 2.

FIG. 4 is a flowchart illustrating a process of collecting and reflecting charger identification information according to the exemplary embodiment of the present disclosure.

FIG. 5 is a flowchart illustrating a process of proceeding with charging using collected charger identification information according to the exemplary embodiment of the present disclosure.

FIG. 6 is an example of a screen for outputting corresponding information as a pop-up according to the exemplary embodiment of the present disclosure.

FIG. 7 is an example of a screen for setting a charging type according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the exemplary accompanying drawings, and because these embodiments, as examples, may be implemented in various different forms by those skilled in the art to which the present disclosure pertains, they are not limited to the exemplary embodiments described herein.

The above-mentioned objects, features, and advantages will be described in detail below with reference to the accompanying drawings, and thus the technical spirit of the present disclosure will be easily conducted by those skilled in the art to which the present disclosure pertains. In the description of the present disclosure, the specific descriptions of publicly known technologies related with the present disclosure will be omitted when it is determined that the specific descriptions may unnecessarily obscure the subject matter of the present disclosure. Hereinafter, various exemplary embodiments of the present disclosure will be described in detail with reference to the accompanying drawings. In the drawings, the same reference numerals are used to indicate the same or similar constituent elements.

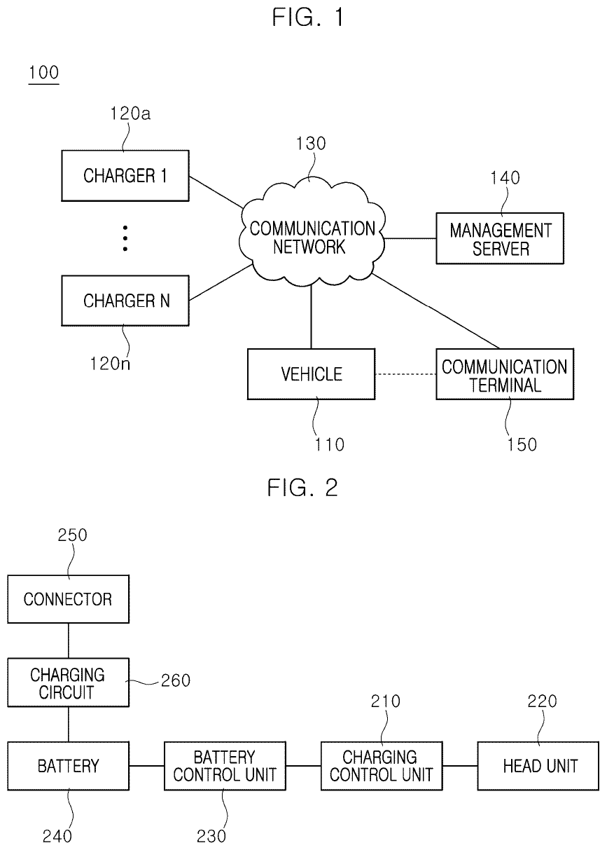

FIG. 1 is a block diagram illustrating a charging system 100 according to an exemplary embodiment of the present disclosure. Referring to FIG. 1, the charging system 100 may include: a vehicle 110; first to n^{th} chargers 120a to 120n; a communication network 130; and a management server 140 configured to collect and store charger identification information on the chargers 120a to 120n through the communication network 130.

The vehicle 110 is a vehicle which is configured for being charged and is mainly an electric vehicle, but is not limited thereto, and may be a vehicle in which a rechargeable battery is provided. Examples of the electric vehicle may include a hybrid electric vehicle (HEV), a plug-in hybrid electric vehicle (PHEV), an electric vehicle (EV), a neighborhood electric vehicle (NEV), a fuel-cell vehicle (FCV) and the like.

The first to n^{th} chargers 120a to 120n may receive power from a power system and provide the power to charge the vehicle 110. The first to n^{th} chargers 120a to 120n are classified into slow chargers, fast chargers, and super-fast chargers according to charging speeds thereof.

Slow charging takes about 7 to 11 hours at 7 to 11 kW. In case of fast charging, 10% to 80% charging is performed for about 1 to 1.5 hours at 50 kW to 100 kW. In case of super-fast charging, 10% to 80% charging is performed for about 18 minutes at about 350 kW.

Furthermore, the first to n^{th} chargers 120a to 120n may include a communication circuit connected to the communication network 130, a microprocessor, and a memory to store the charger identification information. of course, the communication circuit is configured to perform wired communication and/or wireless communication. The charger identification information may include not only information on the charger but also location information, identification information, types of charging services available, waiting time, and the like.

The communication network 130 means a connection structure that enables information exchange between nodes such as a plurality of terminals and servers, and examples thereof may include a public switched telephone network (PSTN), a public switched data network (PSDN), an integrated services digital networks (ISDN), a broadband ISDN (BISDN), a local area network (LAN), a metropolitan area network (MAN), a wide LAN (WLAN), and the like.

However, the communication network 130 according to an exemplary embodiment of the present disclosure is not limited thereto, and examples thereof may include wireless communication networks, such as a Code Division Multiple Access (CDMA), a Wideband Code Division Multiple Access (WCDMA), a Wireless Broadband (WiBro), a wireless fidelity (WiFi), a Digital Living Network Alliance (DLNA), a Zigbee, a Z-wave, a high speed downlink packet access (HSDPA) network, a Bluetooth, a radio frequency identification (RFID), an infrared data association (IrDA), a ultra-wide band, a wireless universal serial bus (Wireless USB), a Near Field Communication (NFC) network, a satellite broadcasting network, an analog broadcasting network, a digital multimedia broadcasting (DMB) network, and the like. Alternatively, the communication network 130 may be a combination of the wired communication networks and wireless communication networks described above.

The management server 140 is configured to perform making a database based on the charger identification information collected through the communication network 130, storing the charger identification information, and providing the charger identification information to the vehicle 110. To the present end, a database may be configured in the management server 140. Information on the vehicle 110 and information on a driver may be stored in the database. Of course, the database may be configured in the management server 140 or may be configured as a separate database server.

The management server 140 may include a communication modem connected to the communication network 130, a microprocessor that processes information, and a memory that stores information.

A communication terminal 150 is connected to the vehicle 110 and/or the communication network 130 to perform a function of providing information. The communication terminal 150 may be a smart phone, a laptop computer, a note pad, and the like.

FIG. 2 is a detailed block diagram of the vehicle 110 illustrated in FIG. 1. Referring to FIG. 2, the vehicle 110 generally may include: a charging control unit 210 configured to control the entire vehicle; a head unit 220 configured to output information; a battery control unit 230 configured to control a battery 240; and a charging circuit 260 configured to charge the battery 240.

The charging control unit 210 is configured to perform performing a control while exchanging signals with constituent elements of the vehicle. To the present end, the charging control unit 210 may include a microprocessor, a microcomputer, a communication circuit, a memory, and the like. Furthermore, the charging control unit 210 may be connected to the communication terminal 150 in a wired or wireless manner.

The memory may be a memory provided in a microprocessor or a microcomputer, or may be a separate memory. Therefore, the memory may be configured as a combination of non-volatile memories such as a flash memory disk (SSD: Solid State Disk), a hard disk drive, a flash memory, an electrically erasable and programmable read-only memory (EEPROM), a static RAM (SRAM), a ferro-electric RAM (FRAM), a phase-change (PRAM), a magnetic RAM (MRAM), and the like and/or volatile memories such as a dynamic random access memory (DRAM), a synchronous dynamic random access memory (SDRAM), a double data rate-SDRAM (DDR-SDRAM), and the like.

The head unit 220 provides vehicle information, an entertainment interface, and the like. The head unit 220 includes a radio, a digital versatile disc/compact disc (DVD/CD), an USB MP3, dashcams, a navigation, Bluetooth, Wi-Fi, a display, and the like. The navigation may be an audio video navigation (AVN). Furthermore, functions such as voice control and motion recognition are integrated. To the present end, a microprocessor, a microprocessor, a communication circuit, a memory, and the like may be configured.

Examples of the display of the head unit 220 may be a liquid crystal display (LCD), a light emitting diode (LED) display, an organic LED (OLED) display, a touch screen, a flexible display, a head up display (HUD), a micro LED, a mini LED, and the like. The touch screen may also be used as an input means.

The battery control unit 230 is configured to perform controlling the battery 240. To the present end, the battery control unit 230 may include a battery management system (BMS). The BMS is configured to optimize battery management for eco-friendly vehicles to increase energy efficiency and extend the battery lifespan.

The BMS is configured to determine battery state information by monitoring a voltage, current, and temperature of the battery in real time to prevent excessive charging and discharging, increasing battery safety and reliability. The battery state information may include a state of charge (SOC), a state of health (SOH), a depth of discharging (DOD), a state of function (SOF), and the like.

The battery 240 includes battery cells disposed in series and/or parallel, and the battery cells may be a high-voltage battery cell for an electric vehicle, such as a nickel metal battery cell, a lithium ion battery cell, a lithium polymer battery cell, a lithium sulfur battery cell, a sodium sulfur battery cell, and an all-solid-state battery cell. In general, a high voltage battery refers to a battery that uses a high voltage of 100 V or more as a power source to move an electric vehicle. However, the battery is not limited thereto, and may also be a low voltage battery.

The charging circuit 260 is configured to perform converting alternating current (AC) into direct current (DC) to charge the battery 240 inside the vehicle. To the present end, the charging circuit 260 may include an input filter configured to remove noise from AC power, which is an input power supply, a power factor corrector (PFC) circuit configured to improve energy efficiency, and a DC/DC converter configured to stably supply power to the battery 240.

Of course, the charging circuit 260 is connected to a connector 250, and the connector 250 is connected to any one of the first to n^{th} chargers 120a to 120n in an outlet-inlet manner. In more detail, when the connector 250 is an inlet, outlets are configured in the first to n^{th} chargers 120a to 120n. Of course, when the connector 250 is an outlet, inlets are configured in the first to n^{th} chargers 120a to 120n.

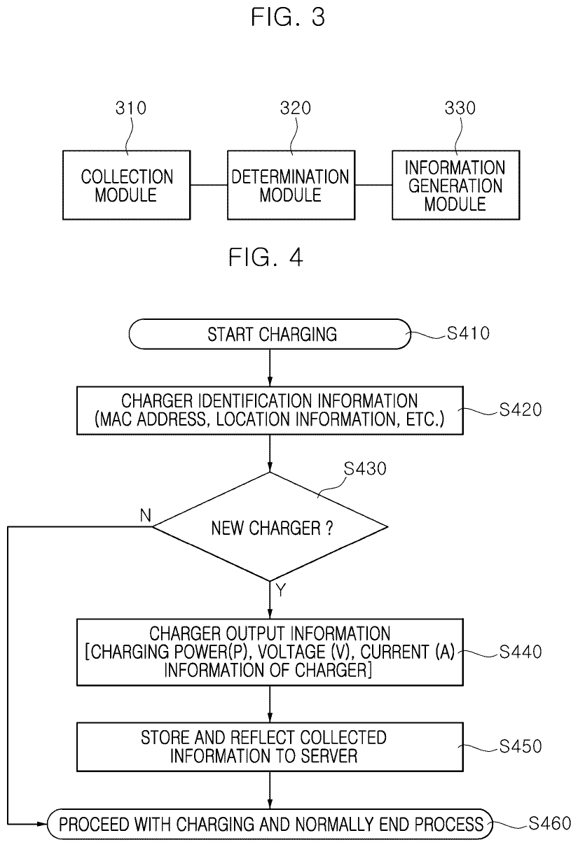

FIG. 3 is a detailed block diagram of the charging control unit 210 illustrated in FIG. 2. Referring to FIG. 3, the charging control unit 210 may include: a collection module 310 configured to collect the charger identification information; a determination module 320 configured to determine whether a charger is a new charger, using the collected charger identification information; and an information generation module 330 configured to store and reflect the collected charger identification information in the database of the management server 140 according to a determination result.

In more detail, the determination module 320 is configured to determine whether a charger is a new charger, using the collected charger identification information. That is, the determination module 320 compares the charger identification information stored in the database with information on the new charger, and is configured to determine that the charger is a new charger when there is no information on the new charger in the charger identification information.

The information generation module 330 collects charger output information when a result of the determining indicates that the charger is the new charger, stores the collected charger output information in the database configured in the management server 140, and transmits the collected charger output information to the vehicle. Of course, the collected charger output information may be provided by generating a reflected application (App).

The collection module 310, determination module 320, and information generation module 330 illustrated in FIG. 2 mean units that process at least one function or operation, and may be implemented in software and/or hardware. In hardware implementation, the collection module 310, determination module 320, and information generation module 330 may be implemented with an application specific integrated circuit (ASIC), a digital signal processing (DSP), a programmable logic device (PLD), a field programmable gate array (FPGA), a processor, a microprocessor, other electronic units or a combination thereof, which are designed to perform the above-described function.

In software implementation, the collection module 310, determination module 320, and information generation module 330 may include a software composition component (an element), an object-oriented software composition component, a class composition component and task composition component, a process, a function, a property, a procedure, a subroutine, a segment of program code, a driver, firmware, a microcode, data, a database, a data structure, a table, an array and a variable. Software, data, and the like may be stored in a memory and executed by a processor. Various means well known to those skilled in the art may be applied to the memory or processor.

FIG. 4 is a flowchart illustrating a process of collecting and reflecting the charger identification information according to the exemplary embodiment of the present disclosure. Referring to FIG. 4, a driver of the vehicle 110 connects the connector 250 to one of the first to n^{th} chargers 120a to 120n to start charging (step S410).

As charging starts, the vehicle 110 collects the charger identification information on a corresponding charger (e.g., 120a) (step S420). In more detail, the charging control unit 210 collects the charger identification information from at least one of the chargers 120a to 120n that are connected for charging.

In more detail, in case of an electric vehicle, when the vehicle is connected to a charger, information on the charger may be identified through a vehicle message transmitted in the vehicle. The vehicle message is a Controller Area Network (CAN) message, but examples thereof may include a Local Interconnect Network (LIN) message, a power line communication (PLC) message, a control pilot (CP) message, and the like.

The charger identification information may include a media access control (MAC) address, which is unique identification information on the charger 120a, location information on the charger 120a, and the like.

When the charger identification information is collected, the charging control unit 210 is configured to determine whether the charger is anew charger based on the collected charger identification information (step S430). In more detail, the charging control unit 210 compares the newly collected charger identification information with a pre-stored charger information list to determine whether the current charger for charging is a new charger. That is, the MAC address and the location information stored in the charger information list are mutually compared to determine whether the charger is a new charger.

Of course, the charger information list may be transmitted in real time from the management server 140 or may be stored in the memory of vehicle. In the instant case, synchronization between the management server and the vehicle may be periodically performed.

In FIG. 4, it is described that the charging control unit 210 is configured to determine whether the charger is a new charger, but the management server 140 may be configured to determine whether the charger is a new charger. In more detail, the management server 140 receives the charger identification information from the charging control unit 210 and compares the pre-stored charger information list with the charger identification information to determine whether the charger is a new charger.

When a result of the determining in step S430 indicates that the charger is a new charger, charger output information on the corresponding charger is collected (step S440). The charger output information may include charging power (W), voltage (V), and current (A) of the charger, and the like. The charger output information may be extracted from the vehicle message.

The vehicle message (precisely, a vehicle CAN message) is represented as a table as follows.

TABLE 1

| Variable | Capacity | | Description |
|---|---|---|---|
| EvseMaxVoltVal | 500.0000 | V | Charger max. voltage |
| EvseMaxCurrVal | 124.000 | A | Charger max. current |
| EvseMaxPwrVal | 50000 | W | Charger max. power value |

The table above is an example of the CAN message for a 50 kW charger (fast charger). Here, Evse is an abbreviation of electric vehicle sourcing equipment.

TABLE 2

| Variable | Capacity | | Description |
|---|---|---|---|
| EvseMaxVoltVal | 835.0000 | V | Charger max. voltage |
| EvseMaxCurrVal | 295.8000 | A | Charger max. current |
| EvseMaxPwrVal | 260000 | W | Charger max. power value |

The table above is an example of the CAN message for a 260 kW charger (fast charger). When the charger output information is collected, the charging control unit 210 transmits and stores the collected charger identification information and/or charger output information to the management server 140 (step S450). Furthermore, the collected charger identification information and/or charger output information is also reflected into the head unit 220 and/or a charging related application. The charging related application (App) is generally provided in the communication terminal 150, but may also be provided in the head unit 220.

Thereafter, charging proceeds and the process is normally ended (step S460).

Meanwhile, when a result of the determining in step S430 indicates that the charger is not the new charger, charging proceeds and the process is normally ended (step S460).

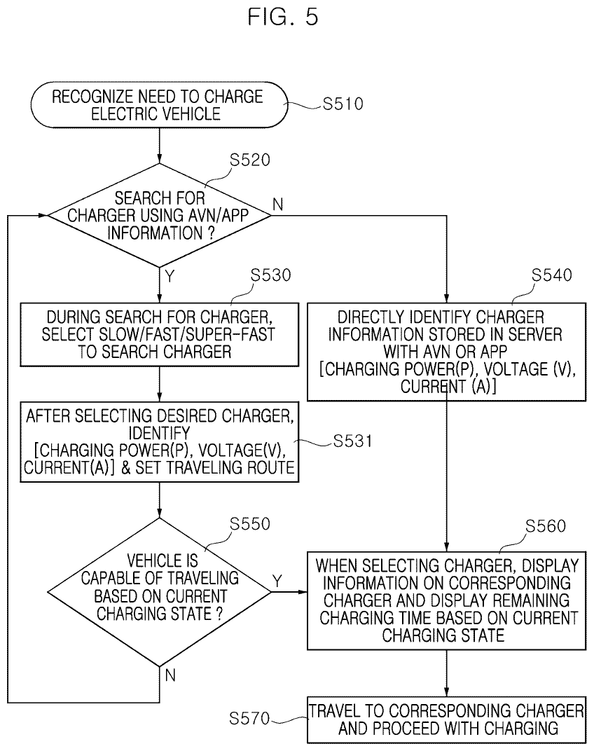

FIG. 5 is a flowchart illustrating a process of proceeding with charging using the collected charger identification information according to the exemplary embodiment of the present disclosure. FIG. 5 is a flowchart illustrating a process of proceeding with charging using the charger identification information which is collected according to FIG. 4. Referring to FIG. 5, the vehicle driver recognizes a need for charging and identifies whether there is a search for a charger which is collected using audio video navigation (AVN) information or charging related application information (steps S510 and S520).

The AVN may be provided in the head unit 220. Furthermore, the communication terminal providing the charging related application information may be connected to the charging control unit 210 in a wired or wireless manner. The AVN information and charging related application information are terms that includes the collected charger identification information, charger output information, charger list, and the like, which is stored in the AVN and charging related application in the vehicle, respectively.

In case that the stored charger has been searched for in step S520, when the driver searches for a charger using the AVN or charging related application information, charging type selection information (e.g., a charging type selection screen) for selecting a charging type is provided, and thus the driver may select the charging type to search for the charger (step S530). FIG. 7 illustrates such charging type selection screen, which will be described later.

Referring to FIG. 5, when searching for a charger, the driver selects the charging type to search for the charger (step S530). The charging type may be slow charging, fast charging, or super-fast charging. That is, when the charging type is selected, the charging control unit 210 outputs a list of search results for chargers collected and stored.

Thereafter, the vehicle driver may select a charger corresponding to the desired charging type, identify charger output information (e.g., charging power, voltage, current of the corresponding charger), and set a traveling route from the current location to the charger (step S531). In more detail, after the charger is selected, the charging control unit 210 receives the traveling route from the current location of the vehicle to the charger which is selected from the list of search results.

Thereafter, based on the received traveling route, the charging control unit 210 is configured to determine whether or not the vehicle is able to travel based on a charging state of battery of the vehicle (step S550). The battery control unit 230 monitors a state of the battery 240 to determine the charging state.

When a result of the determining in step S550 indicates that the vehicle is not capable of traveling based on the current charging state, steps S520, S530, S540, and S550 are performed again.

In contrast, when a result of the determining in step S550 indicates that the vehicle is capable of traveling based on the current charging state, the remaining charge time may be displayed based on the current charging state (step S560). Of course, detailed information on the corresponding charger may be displayed together with the remaining charging time.

Thereafter, the vehicle travels to the corresponding charger and proceeds with charging (step S570).

Meanwhile, in step S520, the vehicle driver may access the management server 140 using the AVN and/or charging related application to directly identify the charger identification information without searching for the stored chargers using the AVN or charging related application information (step S540). The AVN or charging related application may be selectively used, and both the AVN and charging relation application may be used at the same time because either one may malfunction.

In more detail, when the driver accesses the management server 140 through the AVN and/or charging related application, the management server 140 provides the charger type selection information for selecting the charging type of the charger. That is, step S540 describes a method in which the vehicle driver directly accesses the management server 140 and searches for the corresponding charger to be used when the collected charger identification information is not stored in the vehicle.

The charger type selection information may be provided in the form of a web page, and the management server 140 provides the list of search results for the charger to the AVN and/or charging related application when the vehicle driver selects and executes the charging type of the charger from the charger type selection information. of course, not only charger identification information but also charger output information may be configured in the list of search results. Furthermore, check boxes may also be configured side by side with the list of search results to select the corresponding charger.

When the driver selects a final charger from the list of search results, the management server 140 outputs information on the final charger to the head unit 220 or the display of the communication terminal 150 (step S560). Of course, in the instant case, the management server 140 may provide a map to a location of the final charger in a combination of graphics, text, and voice.

Thereafter, the vehicle driver drives the vehicle to a place where the final charger is located and proceeds with charging (step S570).

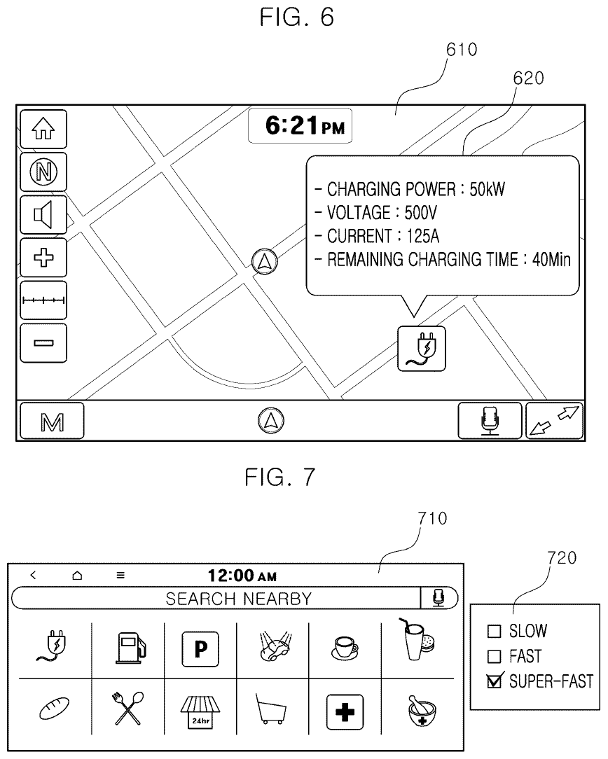

FIG. 6 is an example of a screen for outputting the corresponding information (i.e., charging information) as a pop-up according to the exemplary embodiment of the present disclosure. Referring to FIG. 6, information such as charging power, voltage, current, and remaining charging time is displayed on a corresponding charger icon in the form of pop-up 620 on a map screen 610. The remaining charging time is the time required for charging based on the current SOC value of the vehicle during charging with the finally selected charger. The charging information may include at least one of current, voltage, power, charging time, and charging speed.

FIG. 7 is an example of a screen for setting a charging type according to the exemplary embodiment of the present disclosure. Referring to FIG. 7, charging types are displayed in the form of pop-up 720 on a nearby search screen 710. A route to the charger may be searched after the charging type is set by classifying the charging type into slow (220 V or less)/fast (500 V or less)/super-fast (500 V or more). Of course, after the charging type is automatically set, a route search screen may be displayed.

Furthermore, the steps of a method or algorithm described in connection with the exemplary embodiments included herein may be implemented in the form of program instructions executable by various computer means and then recorded in a computer-readable medium. The computer-readable medium may include program instructions, data files, data structures, or the like, in a stand-alone form or in a combination thereof.

In the instant case, the various computer means may be implemented as an application specific integrated circuit (ASIC), a digital signal processing (DSP), a programmable logic device (PLD), a field programmable gate array (FPGA), a processor, a controller, a microprocessor, other electronic units, or a combination thereof.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular form may also include a plural form. The expression “at least one (or one or more) of A, B, and C” may include one or more of all combinations that may be made by combining A, B, and C.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of collecting charger information, the method comprising:
collecting, by a charging control unit in a vehicle, charger identification information from a charger connected to the vehicle for charging;
determining whether the charger is a new charger from the collected charger identification information; and
collecting, by the charging control unit, charger output information and transmitting the charger identification information and the charger output information to a management server when a result of the determining indicates that the charger is the new charger.

2. The method of claim 1, wherein the charger identification information and the charger output information are extracted from a vehicle message transmitted into the vehicle.

3. The method of claim 1, wherein the charger identification information includes a media access control (MAC) address and location information of the charger.

4. The method of claim 3, wherein the determining of whether the charger is the new charger includes:
comparing, by the charging control unit or the management server, the MAC address and the location information of the collected charger identification information to a MAC address and location information of a pre-stored charger information list.

5. The method of claim 4, wherein the pre-stored charger information list is transmitted in real time from the management server or periodically synchronized with the management server.

6. The method of claim 5, wherein the charger information list is updated by reflecting the charger identification information and the charger output information.

7. The method of claim 1, including:
reflecting, by the charging control unit, the charger identification information and the charger output information on the new charger to a head unit.

8. The method of claim 1, including:
reflecting, by the charging control unit or the management server, the charger identification information and the charger output information on the new charger to a charging related application.

9. The method of claim 1, wherein the charger output information includes charging power, voltage, and current of the charger.

10. The method of claim 1, wherein the charging control unit proceeds with the charging when the result of the determining indicates that the charger is not the new charger.

11. A method of utilizing collected charger information, the method comprising:
receiving a charger search request from a user;
identifying, by a charging control unit, a charger corresponding to the charger search request; and
providing, by the charging control unit, the user with charging information on the identified charger when the charging control unit concludes that the identified charger belongs to a charger information list including the charging information.

12. The method of claim 11, wherein the charging information includes at least one of current, voltage, power, charging time, and charging speed.

13. The method of claim 11, wherein the providing of the user with the charging information includes:
receiving, by the charging control unit, a charger selection command for the identified charger; and
guiding, by the charging control unit, a traveling route from a current location of a vehicle to a selected charger.

14. The method of claim 13, wherein the guiding of the traveling route includes:
determining, by the charging control unit, whether the vehicle is capable of traveling according to the traveling route based on a charging state of a battery of the vehicle.

15. The method of claim 14, including displaying, by the charging control unit, remaining charging time using the charging information, when the charging control unit concludes that the vehicle is capable of traveling according to the traveling route.

16. The method of claim 11, including displaying, by the charging control unit, remaining charging time using the charging information.

17. The method of claim 16, including:
receiving, by a management server, the charger search request directly from the user; and
when the user selects a charger corresponding to the charger search request, displaying charging information on the selected charger.

18. The method of claim 17, including:
when the user selects the charger corresponding to the charger search request, the management server outputs information on the charger corresponding to the charger search request to a head unit or a display of a communication terminal.

19. The method of claim 17, including:
proceeding with charging by the charging control unit, when the vehicle travels along a traveling route and is connected to the selected charger for charging.
